(19) United States
(12) Patent Application Publication
(10) Pub. No.: US 2008/0100666 A1
(43) Pub. Date: May 1, 2008

(54) INKJET PRINTHEAD APPARATUS AND METHOD THEREOF

(75) Inventors: Sang-hyun KIM, Yongin-si (KR); Sung-joon Park, Yongin-si (KR); Bang-weon Lee, Yongin-si (KR); Jin-wook Lee, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/739,217

(22) Filed: Apr. 24, 2007

(30) Foreign Application Priority Data
Oct. 26, 2006 (KR) 2006-104695

(51) Int. Cl. B41J 2/14; B41J 2/16

(52) U.S. Cl. 347/47

(57) ABSTRACT

An inkjet printhead including a substrate through which an ink feed hole is formed to supply ink, a chamber layer formed on the substrate and including a plurality of ink chambers which are filled with ink supplied from the ink feed hole, a nozzle layer formed on the chamber layer and including a plurality of nozzles through which ink is ejected, a plurality of support walls formed between the substrate and the nozzle layer to support the substrate and the nozzle layer, and a method of fabricating the same.

### CROSS-REFERENCE TO RELATED APPLICATIONS

This application claims the priority of Korean Patent Application No. 10-2006-0104695, filed on Oct. 26, 2006, in the Korean Intellectual Property Office, the disclosure of which is incorporated herein in its entirety by reference.

### BACKGROUND OF THE INVENTION

1. Field of the Invention

The present general inventive concept relates to an inkjet printhead and a method of fabricating the same, and more particularly, to a thermal inkjet printhead with a robust and reliable structure.

2. Description of the Related Art

Inkjet printers are devices used to form color images on printing mediums by firing droplets of ink from an inkjet printhead onto a desired region of a corresponding printing medium. Inkjet printers can be classified into shuttle type inkjet printers and line printing type inkjet printers. In shuttle type inkjet printers, an inkjet printhead prints an image while moving back and forth in a direction perpendicular to a feeding direction of a printing medium. Line printing type inkjet printers, which have been recently developed in order to realize high-speed printing, include an array printhead having a length corresponding to a width of a recording medium. The array printhead includes a plurality of inkjet printheads arranged in a predetermined format and perform print jobs while the array printhead is fixed and only the printing medium is manipulated thereby allowing line printing type inkjet printers to print images at higher speeds relative to shuttle type inkjet printers.

Inkjet printheads can be classified into thermal inkjet printheads and piezoelectric inkjet printheads, which are distinguishable by their ink droplet ejecting mechanisms. Thermal inkjet printheads generate bubbles in ink by using heat and eject the ink utilizing the expansion of the bubbles. Piezoelectric inkjet printheads eject ink using a pressure generated by a deformation of a piezoelectric material.

The ink droplet ejecting mechanism of thermal printheads will now be described. When a current is applied to a heater formed of a heat-resistant material, heat is generated from the heater to rapidly increase the temperature of ink adjacent to the heater to approximately 300° C. As a result, bubbles are created in the ink, which is contained in an ink chamber. As more bubbles are created and the bubbles expand, pressure within the ink chamber increases and thereby causes the ink to be pushed out of the ink chamber through a nozzle in the form of droplets.

FIG. 1 is a schematic cross-sectional view of a conventional thermal inkjet printhead. Referring to FIG. 1, the conventional inkjet printhead includes a substrate 10 on which a plurality of material layers are stacked, which include a chamber layer 20 formed above the substrate 10, and a nozzle layer 30 located on the chamber layer 20. The chamber layer 20 includes a plurality of ink chambers 22 filled with ink. The nozzle layer 30 includes nozzles 32 for ejecting ink. An ink feed hole 11 is formed through the substrate 10 to supply ink to the ink chambers 22. The chamber layer 20 further includes a plurality of restrictors 24 that connect the ink chambers 22 with the ink feed hole 11.

An insulating layer 12 is formed on the substrate 10 to insulate the substrate 10 from a heater 14. The heater 14 is formed on the insulating layer 12 to create bubbles by heating the ink filled in the ink chambers 22. Electrode 16 is formed on the heater 14 to apply a current to the heater 14. A passivation layer 18 is formed on the heater 14 and the electrode 16 to protect the heater 14 and the electrode 16. Anti-cavitation layer 19 is formed on the passivation layer 18 to protect the heater 14 from cavitation forces generated when bubbles collapse.

However, during manufacturing of the above inkjet printhead, a process of stacking the layers generates residual stress and a process of coupling the inkjet printhead with an ink cartridge generates thermal stress, which results in deformation of the nozzle layer 30. Also, while forming the ink feed hole 11 through the substrate 10, as illustrated in FIG. 1, the substrate 10 may unintentionally become deformed since the substrate 10 is fragile. As a result, the ink feed hole 11 and the nozzle layer 30 located above the substrate 10 may also become deformed. Furthermore, maintenance of the inkjet printhead may cause the nozzle layer 30 to become deformed, which would prevent ink from being ejected onto a desired region. As the length of the inkjet printhead increases, the possibility of damage increases. Thus, the possibility of damage is even more likely in the line printing type inkjet printers that have been developed to realize high-speed printing.

### SUMMARY OF THE INVENTION

The present general inventive concept provides a thermal inkjet printhead with a robust and reliable structure.

The present general inventive concept also provides a method of fabricating a thermal inkjet printhead with a robust and reliable structure.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet printhead, including a substrate through which an ink feed hole is formed to supply ink, a chamber layer formed on the substrate and including a plurality of ink chambers which are filled with ink supplied from the ink feed hole, a nozzle layer formed on the chamber layer and including a plurality of nozzles through which ink is ejected, and a plurality of support walls formed between the substrate and the nozzle layer to support the substrate and the nozzle layer.

The support walls may be formed on the substrate, may be formed on a sidewall of the chamber layer, may be formed between adjacent ink chambers, and/or may extend across the ink feed hole.

The support walls may be formed to extend in a direction from the sidewall of the chamber layer, such as in one of a perpendicular, parallel, horizontal and vertical direction.

The support walls may be formed between adjacent ink chambers and in portions corresponding to center portions between the adjacent ink chambers.

The support walls may be formed between sidewalls of the chamber layer that face each other to traverse the ink feed hole.

The support walls may extend between sidewalls of the chamber layer that face each other.

The support walls may extend from portions of the sidewalls of the chamber layer that are centrally between adjacent ink chambers.

A plurality of ink restrictors may be formed in the chamber layer to connect the ink feed hole with the ink chambers and to provide fluid communication therebetween.

The ink restrictors may have a width smaller than a width of the ink chambers.

The ink feed hole may be formed through the substrate in a direction perpendicular to an upper surface of the substrate.

An insulating layer may be formed on a surface of the substrate.

A plurality of heaters may be formed on the insulating layer to create bubbles by heating ink filled in the ink chambers, and electrodes may be formed on each of the heaters to supply a current to the heaters.

A passivation layer may be formed on the heaters and the electrodes to protect the heaters and the electrodes.

An anti-cavitation layer may be formed on the passivation layer to protect the heaters from cavitation forces generated when the bubbles collapse.

The foregoing and/or other aspects and utilities of the present general inventive concept may further be achieved by providing a substrate having an ink feed hole, a nozzle layer having a nozzle, a chamber layer formed between the nozzle layer and the substrate and having an ink chamber and a restrictor, and a support wall to communicate with the ink feed hole and extending from the chamber layer toward the ink feed hole.

The support wall may be formed on the substrate to support the nozzle layer with respect to the substrate.

The chamber layer may form an ink passage between the nozzle and the ink feed hole, and the support wall may be disposed in the ink passage.

The ink chamber may include a plurality of ink chambers, the restrictors may include a plurality of restrictors corresponding to respective ink chambers, and the support wall may include a plurality of support walls disposed between adjacent restrictors along the chamber wall.

The support wall may be a block.

The support wall may extend across the ink feed hole for reinforcement of the inkjet printhead.

The support wall may bridge a gap created by the ink feed hole to allow a transfer of mechanical force between layers that are separated by the ink feed hole and face each other.

The support wall may allow a transfer of mechanical force between the substrate and the nozzle layer.

The support wall may form at least one channel for guiding ink into ink chambers.

The support wall may form at least one channel to allow fluid communication between ink chambers that are separated by the ink feed hole and face each other.

The support wall may have a height equal to or greater than a height of the ink chamber layer.

The chamber layer may include a first row of ink chambers and restrictors and a second row of ink chambers and restrictors disposed to face the first row with respect to the ink feed hole, and the support wall may extend from a side of the first row toward a side of the second row.

The foregoing and/or other aspects and utilities of the present general inventive concept may further be achieved by providing a method of manufacturing an inkjet printhead including forming a substrate having an ink feed hole, forming a nozzle layer having a nozzle, forming a chamber layer between the nozzle layer and the substrate having an ink chamber and a restrictor to communicate with the ink feed hole, and forming a support wall extending from the chamber layer toward the ink feed hole.

The forming of the ink chamber layer may include forming a plurality of ink chamber layers having a plurality of ink chambers, and the forming of the restrictor may include forming a plurality of restrictors corresponding to respective ink chambers.

The forming of the support wall may include forming a block that extends across the ink feed hole.

The forming of the chamber layer may include forming a first row of ink chambers and restrictors and forming a second row of ink chamber and restrictors disposed to face the first row with respect to the ink feed hole, and the forming of the support wall may include extending the support wall from a side of the first row toward a side of the second row.

The forming of the support wall may include forming at least one channel to allow fluid communication between the ink chambers that are separated by the ink feed hole and face each other.

The support wall may bridge a gap created by the ink feed hole to allow a transfer of mechanical force between the ink chamber layers that are separated by the ink feed hole and face each other.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a cross-sectional view of a conventional thermal inkjet printhead;

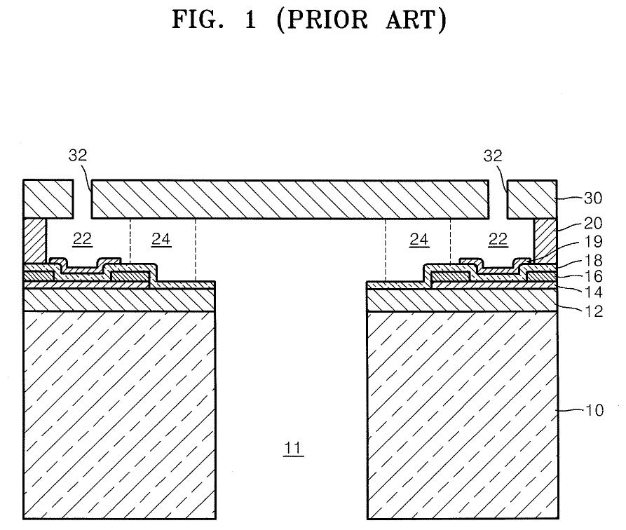

FIG. 2 is a schematic plan view of an inkjet printhead according to an embodiment of the present general inventive concept;

FIG. 3 is a schematic exploded perspective view of the inkjet printhead of FIG. 2, according to an embodiment of the present general inventive concept;

FIG. 4 is a sectional view taken along line IV-IV′ of FIG. 2, according to an embodiment of the present general inventive concept;

FIG. 5 is a schematic plan view of an inkjet printhead according to an embodiment of the present general inventive concept;

FIG. 6 is a schematic exploded perspective view of the inkjet printhead of FIG. 5, according to an embodiment of the present general inventive concept; and

FIG. 7 is a sectional view taken along line VII-VII′ of FIG. 5, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

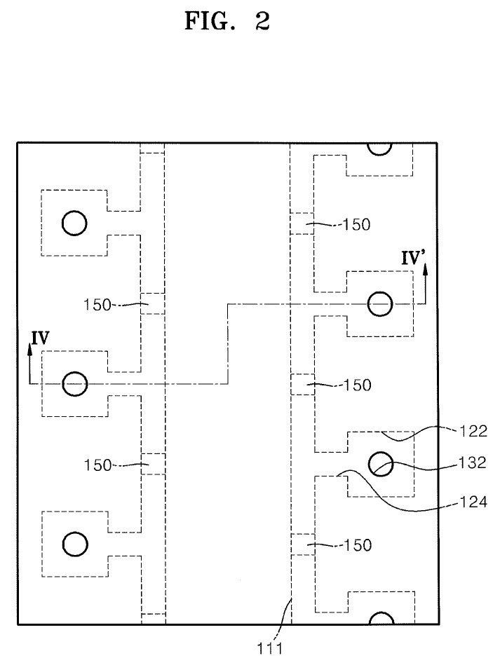

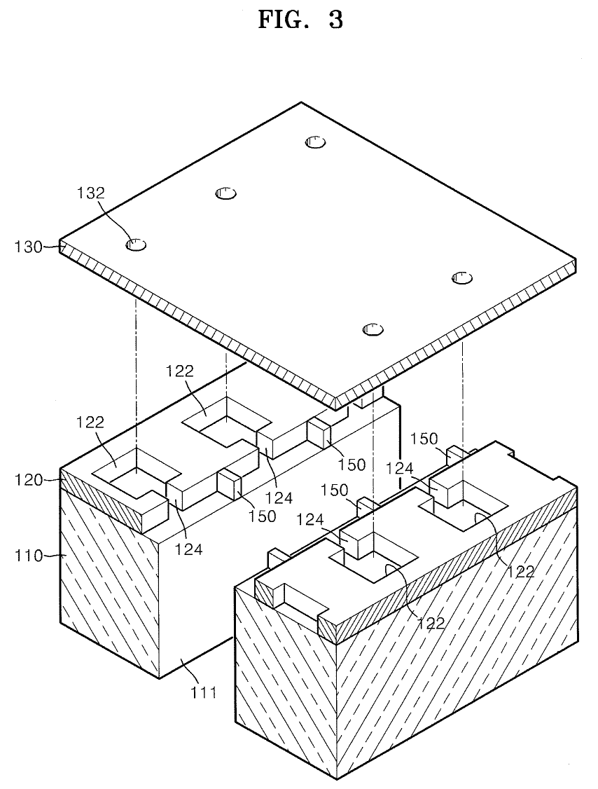

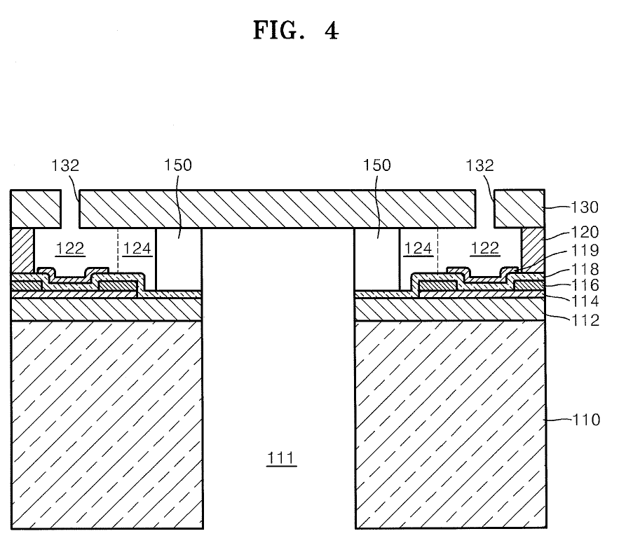

FIG. 2 is a schematic plan view of an inkjet printhead according to an embodiment of the present general inventive concept. FIG. 3 is a schematic exploded perspective view of the inkjet printhead of FIG. 2, according to an embodiment of the present general inventive concept. FIG. 4 is a sectional view taken along line IV-IV′ of FIG. 2, according to an embodiment of the present general inventive concept.

Referring to FIGS. 2 through 4, the inkjet printhead includes a substrate 110 on which a plurality of material layers are formed, including a chamber layer 120 formed above the substrate 110, a nozzle layer 130 formed on the chamber layer 120, and a plurality of support walls 150 formed between the substrate 110 and the nozzle layer 130. A plurality of ink chambers 122 are formed in the chamber layer 120, and a plurality of nozzles 132 are formed in the nozzle layer 130.

It is foreseen that a silicon wafer may be generally used as the substrate 110 or other material(s) having similar properties. An ink feed hole 111 is formed in the substrate 110 to supply ink. The ink feed hole 111 may be formed through the substrate 110 in a direction perpendicular to the upper surface of the substrate 110. While the present general inventive concept illustrates the ink feed hole 111 formed in the substrate 110 as a single ink feed hole 111, it is foreseen that a plurality of ink feed holes may be formed therein based on factors such as, but not limited to, number of ink chambers, location and/or accessibility of the ink chamber(s), ink feed mechanism configuration, and/or likelihood of deformation of the substrate, and/or other layers.

An insulating layer 112 may be formed on the substrate 110 for electrically insulating the substrate 110 and heaters 114 from each other. It is foreseen that the insulating layer 112 may be formed of, for example, a silicon oxide, although other materials having similar properties may be used. The heaters 114 are formed on the insulating layer 112 to create bubbles by heating ink filled in the ink chambers 122. The heaters 114 may be formed of a heat-resistant material such as, for example, a tantalum-aluminum alloy, a tantalum nitride, a titanium nitride, a tungsten silicide, or other material(s) having similar properties. Electrodes 116 are formed on the heaters 114 to apply a current to each of the heaters 114. The electrodes 116 are formed of a material having high electric conductivity, for example, aluminum (Al), an aluminum alloy, gold (Au), silver (Ag), or other material(s) having similar properties.

Further, a passivation layer 118 may be formed on the heaters 114 and the electrodes 116. The passivation layer 118 prevents the heaters 114 and the electrodes 116 from oxidizing or corroding due to contact with ink. The passivation layer 118 may be formed of, for example, a silicon oxide, a silicon nitride, or other material(s) having similar properties. A plurality of anti-cavitation layers 119 may be further formed on a bottom surface of the ink chambers 122. That is, the anti-cavitation layers 119 may be formed on the passivation layer 118 above the heaters 114. The anti-cavitation layers 119 protect the heaters 114 from cavitation forces generated when ink bubbles collapse. The anti-cavitation layers 119 may be formed of, for example, tantalum (Ta), or other material(s) having similar properties.

The chamber layer 120 is formed on the substrate 110 on which a plurality of material layers are formed. The plurality of ink chambers 122 can be filled with ink supplied from the ink feed hole 111, and can be formed in the chamber layer 120. The ink chambers 122 may be located above the heaters 114. Further, a plurality of restrictors 124 may be formed in the chamber layer 120 to connect the ink feed hole 111 with the ink chambers 122. The restrictors 124 may have a smaller width than a width of the ink chambers 122. The chamber layer 120 may be formed of, for example, a polymer, or other material(s) having similar properties.

The nozzle layer 130 is formed on the chamber layer 120. The ink filled in the ink chambers 122 is ejected out through the plurality of nozzles 132 of the nozzle layer 130. The nozzles 132 can be located above respective ink chambers 122. The nozzle layer 130 may be formed of, for example, a polymer, or other material(s) having similar properties.

The plurality of support walls 150 can be formed between the substrate 110 on which the plurality of material layers are formed and the nozzle layer 130 to support the substrate 110 and the nozzle layer 130. The support walls 150 may structurally reinforce the mechanical integrity of the inkjet printhead. The support walls 150 can be formed on the substrate 110 between the ink feed hole 111 and sidewalls of the chamber layer 120. The sidewalls of the chamber layer 120 may be located between adjacent ink chambers 122. The support walls 150 may be formed to extend from the sidewalls of the chamber layer 120. The support walls 150 may be formed in portions corresponding to center portions between the adjacent ink chambers 122. The support walls 150 may be disposed between the adjacent restrictors 124. The support walls 150 are formed to have substantially the same height or greater than a height of the chamber layer 120. Therefore, upper surfaces of the support walls 150 contact the nozzle layer 130, and lower surfaces of the support walls 150 contact the substrate 110 on which the material layers are formed in order to allow a transfer of mechanical force or stress between the nozzle layer 130 and the substrate 110. The support walls 150 may be formed of the same material as the chamber layer 120. The support walls 150 may be extended from a side of the chamber layer 120, which forms the chambers 122 and the restrictors 124, and toward the ink feed hole 111. It is foreseen that the support walls 150 may consist of a single support wall. It is also foreseen that the support walls 150 may be blocks of varying geometric shapes, such as, but not limited to blocks having straight walls, such as a rectangle, blocks having curved walls, such as an arch, blocks having sloped or angled walls, such as a triangle or a polygon, such as a quadrilateral structure. Further, since an ink passage is formed from the ink feed hole 111 toward the nozzle 132 through the restrictor 124 and the ink chamber 122 along a space between the substrate 110 and the nozzle layer 130, it is foreseen that a support wall may be formed between adjacent ink passages. Even further, since two rows of the chamber layer 120 form a space at the ink feed hole 111, it is foreseen that a support wall may support a portion of the nozzle layer 130 with respect to the substrate 110.

As described above, deformation of the substrate 110 and the nozzle layer 130 can be prevented during a stacking process and/or a coupling of the inkjet printhead and an ink cartridge process by the plurality of support walls 150 formed between the substrate 110 and the nozzle layer 130. Also, failure of the nozzle layer 130, which may occur during maintenance of the inkjet printhead, can be prevented, thus improving the ability of ink ejection. In addition, if the ink feed hole 111 has a uniform width and is not deformed, then a uniform quantity of ink can be supplied at a uniform speed from the ink feed hole 111 to each of the ink chambers 122, thus resulting in uniform ink ejection from each of the nozzles 132. Also, the support walls 150 may be formed on the substrate 110 between portions of the sidewalls of the chamber layer 120 between the adjacent ink chambers 122 and the ink feed hole 111, in order to prevent cross talk or other undesired interference that may be caused between ink chambers 122.

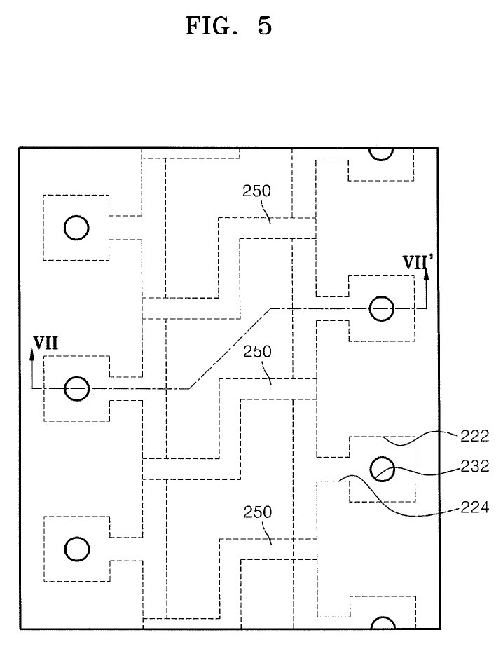

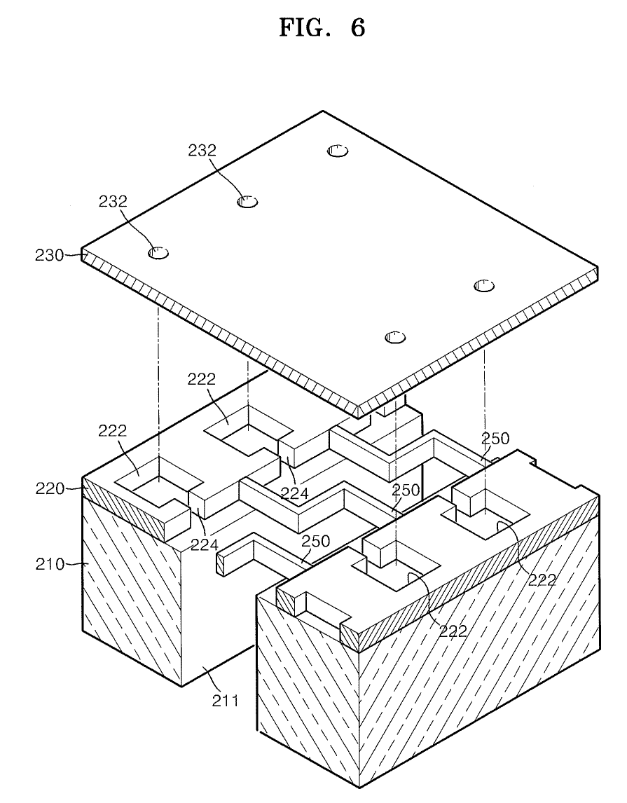

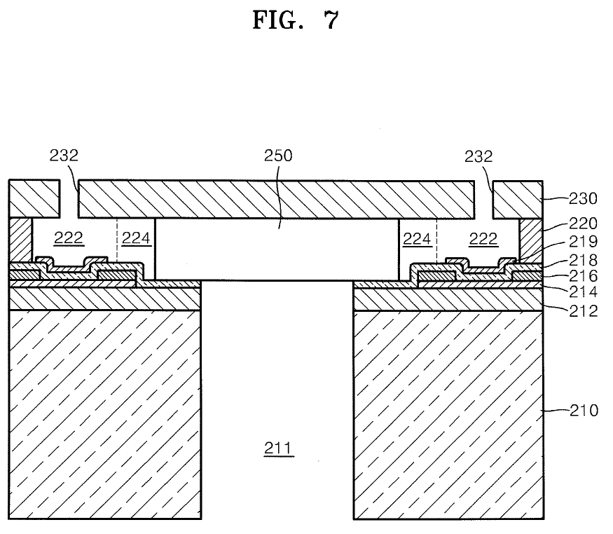

FIG. 5 is a schematic plan view of an inkjet printhead according to an embodiment of the present general inventive concept. FIG. 6 is a schematic exploded perspective view of the inkjet printhead of FIG. 5, according to an embodiment of the present general inventive concept. FIG. 7 is a sectional view taken along line VII-VII′ of FIG. 5, according to an embodiment of the present general inventive concept. Hereinafter, aspects of the present embodiment which differ from the above embodiment will be described.

Referring to FIGS. 5 through 7, the inkjet printhead includes a substrate 210 on which a plurality of material layers are formed, including a chamber layer 220 formed above the substrate 210, a nozzle layer 230 formed on the chamber layer 220, and a plurality of support walls 250 formed between the substrate 210 and the nozzle layer 230. An ink feed hole 211 is formed through the substrate 210 to supply ink. A plurality of ink chambers 222 are formed in the chamber layer 220, and a plurality of nozzles 232 are formed in the nozzle layer 230. An insulating layer 212, a plurality of heaters 214, a plurality of electrodes 216, a passivation layer 218, and anti-cavitation layers 219 may be sequentially formed on the substrate 210.

The chamber layer 220 is formed on the substrate 210 on which a plurality of material layers are formed. The plurality of ink chambers 222 which are filled with ink supplied from the ink feed hole 211 are formed in the chamber layer 220. Further, a plurality of ink restrictors 224 may be formed in the chamber layer 220 to connect the ink feed hole 211 with the ink chambers 222 and provide fluid communication therebetween. It is foreseen that the restrictors 224 could be made integral with support walls 250 whereby a support wall restrictor would restrict ink flow from an ink feed hole to ink chambers. The nozzle layer 230 is formed on the chamber layer 220. The ink filled in the ink chambers 222 is ejected out through the plurality of nozzles 232 of the nozzle layer 230.

The plurality of support walls 250 are formed between the substrate 210 on which the plurality of material layers are formed and the nozzle layer 230 to support the substrate 210 and the nozzle layer 230. The support walls 250 are formed between sidewalls of the chamber layer 220 that face each other interposing the ink feed hole 211. Specifically, the support walls 250 may extend between sidewalls of the chamber layer 220 that face each other to traverse, extend across, or bridge a gap created by the ink feed hole 211. The support walls 250 may extend from the sidewalls of the chamber layer 220 corresponding to center portions between the ink chambers 222 in order to transfer mechanical force or stress between sidewalls of the chamber layer 220 or between other layers. The support walls 250 may create a single channel or a plurality of channels to facilitate the distribution of ink from the ink feed hole 211 and into the ink chambers 222. The support walls 250 may provide fluid communication between ink chambers 222. The support walls 250 are formed to be substantially the same or greater than a height of the chamber layer 220. Therefore, upper surfaces of the support walls 250 contact the nozzle layer 230, and lower surfaces of both ends of the support walls 250 contact the substrate 210 in order to allow a transfer of mechanical force, such as stress. The support walls 250 may be formed of the same material as the chamber layer 220. It is foreseen that the support walls 250 may consist of a single support wall. It is also foreseen that the support walls 250 may be blocks of varying geometric shapes, such as, but not limited to blocks having straight walls, such as a rectangle, blocks having curved walls, such as an arch, blocks having sloped or angled walls, such as a triangle or a polygon, such as a quadrilateral structure.

As described above, the plurality of support walls 250 may be formed between the substrate 210 and the nozzle layer 230, in order to prevent deformation of the substrate 210 and the nozzle layer 230. Also, failure of the nozzle layer 230, which may occur during maintenance of the inkjet printhead, can be prevented, thus improving ink ejection. In addition, if the ink feed hole 211 has a uniform width and is not deformed, then a uniform quantity of ink can be supplied at a uniform speed from the ink feed hole 211 to each of the ink chambers 222, thus resulting in uniform ink ejection from each of the nozzles 232. Also, the support walls 250 may be formed on the substrate 210 and to extend between portions of the sidewalls of the chamber layer 220 between ink chambers 222, in order to prevent cross talk or other undesired interference that may be caused between the ink chambers 222. Furthermore, since the support walls 250 connect the sidewalls of the chamber layer 220 that face each other interposing the ink feed hole 211, deformation of the substrate 210, and particularly, deformation of the substrate 210 in a direction perpendicular to the upper surface of the substrate 210 may be prevented. Accordingly, if the ink feed hole 211 is formed to have a uniform width in a vertical direction, then a uniform quantity of ink can be supplied at a uniform speed from the ink feed hole 211 to each of the ink chambers 222, thus resulting in uniform ink ejection from each of the nozzles 232.

As described above, the present general inventive concept has following effects.

A plurality of support walls are formed between a substrate and a nozzle layer in order to prevent deformation of the substrate and the nozzle layer during a stacking process or a coupling process of the inkjet printhead and an ink cartridge. Also, failure of the nozzle layer which may occur during maintenance of the inkjet printhead can be prevented, thus improving ink ejection.

Also, since an ink feed hole has a uniform width and is not deformed, ink of a uniform amount can be supplied at a uniform speed from the ink feed hole to each ink chamber, and thus the ink ejecting property can be uniform between nozzles.

In addition, since the support walls are formed between ink chambers, cross talk and/or other interference can be prevented between ink chambers when ink is ejected.

Furthermore, when the support walls are formed between sidewalls of a chamber layer that face each other to traverse the ink feed hole, the substrate can be effectively prevented from being deformed in a direction perpendicular to the upper surface of the substrate. As a result, the ink feed hole has a vertically uniform width, thus allowing increased uniformity of ink ejection between each nozzle.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet printhead, comprising:
a substrate through which an ink feed hole is formed to supply ink;
a chamber layer formed on the substrate and including a plurality of ink chambers which are filled with ink supplied from the ink feed hole;
a nozzle layer formed on the chamber layer and including a plurality of nozzles through which ink is ejected; and
a plurality of support walls formed between the substrate and the nozzle layer to support the substrate and the nozzle layer.

2. The inkjet printhead of claim 1, wherein the support walls are formed on the substrate, are formed on a sidewall of the chamber layer, are formed between adjacent ink chambers, and extend across the ink feed hole.

3. The inkjet printhead of claim 1, wherein the support walls are formed on a sidewall of the chamber layer and extend perpendicular from the sidewall of the chamber layer.

4. The inkjet printhead of claim 1, wherein the support walls are formed between adjacent ink chambers and are formed in portions corresponding to center portions between the adjacent ink chambers.

5. The inkjet printhead of claim 1, wherein the support walls are formed between sidewalls of the chamber layer that face each other to traverse the ink feed hole.

6. The inkjet printhead of claim 5, wherein the support walls extend between sidewalls of the chamber layer that face each other.

7. The inkjet printhead of claim 6, wherein the support walls extend from portions of the sidewalls of the chamber layer that are centrally between adjacent ink chambers.

8. The inkjet printhead of claim 1, further comprising:
a plurality of ink restrictors formed in the chamber layer to connect the ink feed hole with the ink chambers and to provide fluid communication therebetween.

9. The inkjet printhead of claim 8, wherein the ink restrictors have a width smaller than a width of the ink chambers.

10. The inkjet printhead of claim 1, wherein the ink feed hole is formed through the substrate in a direction perpendicular to an upper surface of the substrate.

11. The inkjet printhead of claim 1, further comprising:
an insulating layer formed on a surface of the substrate.

12. The inkjet printhead of claim 11, further comprising:
a plurality of heaters formed on the insulating layer to create bubbles by heating ink filled in the ink chambers, and electrodes formed on each of the heaters to supply a current to the heaters.

13. The inkjet printhead of claim 12, further comprising:
a passivation layer formed on the heaters and the electrodes to protect the heaters and the electrodes.

14. The inkjet printhead of claim 13, further comprising:
an anti-cavitation layer formed on the passivation layer to protect the heaters from cavitation forces generated when the bubbles collapse.

15. An inkjet printhead, comprising:
a substrate having an ink feed hole;
a nozzle layer having a nozzle;
a chamber layer formed between the nozzle layer and the substrate and having an ink chamber and a restrictor; and
a support wall to communicate with the ink feed hole and extending from the chamber layer toward the ink feed hole.

16. The inkjet printhead of claim 15, wherein the support wall is formed on the substrate to support the nozzle layer with respect to the substrate.

17. The inkjet printhead of claim 15, wherein the chamber layer forms an ink passage between the nozzle and the ink feed hole, and the support wall is disposed in the ink passage.

18. The inkjet printhead of claim 15, wherein the ink chamber comprises a plurality of ink chambers, the restrictor comprises a plurality of restrictors corresponding to respective ink chambers, and the support wall comprises a plurality of support walls disposed between adjacent restrictors along the chamber layer.

19. The inkjet printhead of claim 15, wherein the support wall is a block.

20. The inkjet printhead of claim 15, wherein the support wall extends across the ink feed hole for reinforcement of the inkjet printhead.

21. The inkjet printhead of claim 15, wherein the support wall bridges a gap created by the ink feed hole to allow a transfer of mechanical force between layers that are separated by the ink feed hole and face each other.

22. The inkjet printhead of claim 15, wherein the support wall allows a transfer of mechanical force between the substrate and the nozzle layer.

23. The inkjet printhead of claim 15, wherein the support wall forms at least one channel for guiding ink into the ink chamber.

24. The inkjet printhead of claim 18, wherein the support wall forms at least one channel to allow fluid communication between the ink chambers that are separated by the ink feed hole and face each other.

25. The inkjet printhead of claim 15, wherein the support wall has a height equal to or greater than a height of the chamber layer.

26. The inkjet printhead of claim 15, wherein the chamber layer comprises a first row of ink chambers and restrictors and a second row of ink chambers and restrictors disposed to face the first row with respect to the ink feed hole, and the support wall extends from a side of the first row toward a side of the second row.
